(19) United States
(12) Patent Application Publication
(10) Pub. No.: US 2026/0280777 A1
(43) Pub. Date: Sep. 17, 2026

(54) METHODS, SYSTEMS, AND COMPUTER READABLE MEDIA FOR DETECTING RETRY WINDOW INVOCATION FOR TESTING LINK LEVEL RETRY (LLR)

(71) Applicant: Keysight Technologies, Inc., Santa Rosa, CA (US)

(72) Inventor: Pinaki Chakrabarti, League City, TX (US)

(21) Appl. No.: 19/667,698

(22) Filed: May 5, 2026

(51) Int. Cl. H04L 1/24

(52) U.S. Cl. CPC H04L 1/245; H04L 1/242

(57) ABSTRACT

A test device emulating a link level receiver detects invocation of a link level retry (LLR) retry window by a device under test (DUT). The test device receives LLR-eligible frames having expected sequence numbers and determines a next expected sequence number. Upon receipt of out-of-sequence LLR-eligible frames having sequence numbers greater than the next expected sequence number, the test device stores a last good sequence number associated with a last in-sequence frame and stores a highest sequence number observed among the out-of-sequence frames. Using the stored last good sequence number and highest sequence number, the test device identifies when subsequently received frames correspond to retransmission within the retry window. While the retry window is identified, the test device verifies at least one behavior of the DUT within the retry window.

### TECHNICAL FIELD

The subject matter described herein relates to testing implementations of link level retry (LLR) in devices. More particularly, the subject matter described herein relates to detecting retry window invocation by a sending device under test (DUT) and verifying behavior of the sending DUT during the retry window invocation.

### BACKGROUND

Link level retry is a technique used in Ethernet communications to enable a receiver to request a sender to retry Ethernet frames that are not received on the receiver side. Link level retry is implemented using sequence numbers communicated with Ethernet frames transmitted by the sender, acknowledgements (ACKs) communicated by the receiver to the sender that acknowledge frames successfully received, and negative acknowledgements (NACKs) when a receiver receives an out of sequence frame. The sender maintains a replay buffer and stores frames that have not been acknowledged in the replay buffer. When the sender receives a NACK with an indication of the last good sequence number received by the receiver, the sender sends frames in the replay buffer, beginning with the frame having the last good sequence number+1. For example, if the NACK indicates that the last good sequence number is 3, the sender sends all frames in the replay buffer, starting with frame 4. The transmission of frames by the sender from the replay buffer is referred to as the retry window.

It is desirable to test the compliance of the LLR sender with LLR standards during LLR retry window invocation. LLR is defined in the Ultra Ethernet Specification, v1.0.1, Sep. 5, 2025 (hereinafter, “Ultra Ethernet Specification”), the disclosure of which is incorporated herein by reference in its entirety. For example, when an LLR sender is transmitting frames from the replay buffer during LLR, the LLR sender should only transmit LLR-eligible frames to the receiver. However, it is difficult for a test device emulating the receiver to know when the LLR sender is invoking the retry window versus transmitting original LLR frames because the test device discards frames after receiving an out-of-sequence frame. If the test device does not know whether the sender is invoking the retry window, the test device cannot confirm proper LLR sender behavior during LLR invocation.

Accordingly, in light of these and other difficulties, there exists a need for improved methods, systems, and computer readable media for testing the functionality of an LLR sender during LLR retry window invocation.

### SUMMARY

In accordance with some aspects, a test device emulating a link level receiver detects invocation of a link level retry (LLR) retry window by a device under test (DUT) based on sequence-number information observed on a link. The test device receives LLR-eligible frames having expected sequence numbers, determines a next expected sequence number, and upon receiving out-of-sequence LLR-eligible frames having sequence numbers greater than the next expected sequence number, stores both (i) a last good sequence number and (ii) a highest sequence number observed among the out-of-sequence frames. Using the stored last good sequence number and the stored highest sequence number, the test device identifies when the DUT is transmitting frames within a retry window and verifies at least one DUT behavior within the retry window.

The test device may identify a frame having a sequence number equal to (last-good+1) as a first frame of the retry window and may treat subsequently received frames having sequence numbers less than or equal to the highest sequence number as occurring within the retry window.

The verified behavior may include verifying at least one Ultra Ethernet link level behavior during the retry window, including verifying that the DUT does not pause retransmission of previously transmitted frames in response to receiving a pause frame.

The verified behavior may include verifying that the DUT transmits only LLR-eligible frames within the retry window.

The verified behavior may include determining whether the DUT updates S_VC_CC counters within the retry window and/or determining whether the DUT transmits a CC_Update frame within the retry window.

In some aspects, the subject matter is implemented as a system comprising at least one processor and a memory storing instructions that, when executed, perform the operations described herein.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a message flow diagram illustrating an example of link level retry (LLR) between an LLR sender and an LLR receiver, including acknowledgement (ACK), negative acknowledgement (NACK), and retry-window retransmission;

FIG. 2 is a message flow diagram illustrating an example technique by which a test device emulating an LLR receiver identifies retry-window boundaries using stored sequence-number information;

FIG. 3A is a message flow diagram illustrating a test scenario in which a test device transmits a pause frame during an identified retry window and verifies that the LLR sender continues retransmission without pausing.

FIG. 3B is a message flow diagram illustrating a non-compliant scenario in which an LLR sender pauses retransmission in response to a pause frame received during the retry window;

FIG. 4 is a message flow diagram illustrating detection of non-compliant sender behavior in which an LLR-ineligible frame is retransmitted during an LLR retry window;

FIG. 5 is a message flow diagram illustrating detection of non-compliant sender behavior in which S_VC_CC counters are updated during an LLR retry window;

FIG. 6 is a message flow diagram illustrating detection of non-compliant sender behavior in which a CC_Update frame is transmitted during an LLR retry window;

FIG. 7 is a block diagram illustrating an example test device architecture for emulating an LLR receiver, identifying retry-window invocation, and verifying LLR sender behavior during the retry window; and

FIG. 8 is a flow chart illustrating an exemplary process performed by a test device emulating an LLR receiver for determining when a DUT is transmitting within an LLR retry window and for verifying one or more DUT behaviors within the retry window.

### DETAILED DESCRIPTION

LLR helps to detect frame loss on an Ethernet link and retry lost frames. To implement LLR, a sender inserts an incrementing sequence number in the preamble of each LLR-eligible Ethernet frame transmitted to a receiver. The receiver checks the sequence number of each received LLR-eligible frame. If the sequence number of a received LLR-eligible frame equals the next expected sequence number, the receiver sends an acknowledgement (ACK) to the sender. If the sequence number of a received LLR-eligible frame is not equal to the next expected sequence number, then the receiver sends a negative acknowledgement (NACK) to the sender, the NACK indicating the last good sequence number received, and the sender begins retransmission of LLR-eligible frames from the replay buffer.

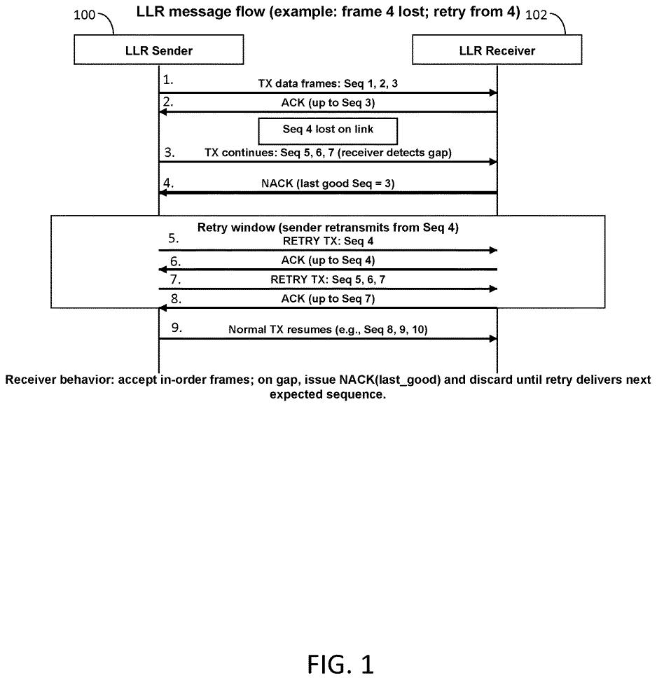

FIG. 1 illustrates an example of link level retry between an LLR sender and an LLR receiver. In line 1 of the illustrated message flow, LLR sender 100 transmits a sequence of LLR-eligible frames with increasing sequence numbers. An LLR receiver 102 successfully receives frames 1, 2, and 3 and, in line 2, returns an ACK indicating receipt through sequence number 3. Frame 4 is lost on the link, and, in line 3, LLR sender 100 continues transmitting frames 5, 6, and 7. Upon receiving frame 5 when frame 4 is the next expected sequence number, in line 4, LLR receiver 102 detects an out-of-sequence condition (a gap between 3 and 5) and, in line 4, transmits a NACK identifying the last good sequence number as 3. In response to the NACK, in line 5, LLR sender 100 enters a retry window and retransmits frames starting with sequence number 4 from its replay buffer, followed by retransmission of frames 5, 6, and 7 (line 7). After LLR receiver 102 receives the retransmitted frame 4, in-order reception resumes and the receiver acknowledges progress (e.g., ACK through 4 (line 6) and then ACK through 7 (line 8)), after which normal transmission can continue with subsequent new frames (line 9).

To implement LLR, the sender keeps a replay buffer. After sending a frame, the sender keeps the frame in the replay buffer. When the sender receives an ACK from the receiver, the sender removes acknowledged frames from the replay buffer. In the example illustrated in FIG. 1, if receiver 102 sends an ACK with sequence number==2, sender 100 will remove frames {1, 2} from the replay buffer.

### Retry Window

A retry window is when the sender is retrying frames present in its replay buffer. Consider the following example. Assume the sender is going to send frames 1 . . . 10. The sender sends 1, 2, 3, 4, 5, 6, 7 and then receives a NACK requesting retry from sequence number 4. The overall frame sequence on the wire looks like 1, 2, 3, 5, 6, 7, 4, 5, 6, 7, 8, 9, 10. The bold frames 4, 5, 6, 7 indicate the retry window. In FIG. 1, lines 6-9 represent the retry window.

### Sender Behaviors During Retry Window Invocation

The Ultra Ethernet Specification mandates the following sender behaviors during retry window invocation:
1. Section 5.1: page 463:
   However, it should be noted that the reception of pause frames does not stop the retry of previously sent data frames by LLR and acts only on new data frames (LLR-ineligible or LLR-eligible) from the LLC/MAC client layer.
2. Section 5.2.9: page 504:
   The LLR protocol also requires the sender to retransmit only LLR-eligible frames within an LLR retry window.
3. Section 5.2.9: page 504: that the retransmission of LLR-eligible frames during the LLR retry window must not update the S_VC_CC counters.
4. Section 5.2.9: page 508: During the LLR retry window, no new CC_Update frame shall be transmitted.

In a test scenario, it is desirable to confirm that the LLR sender is correctly implementing the above-specified LLR sender behaviors during retry window invocation. One challenge in verifying LLR sender behavior is that, from the sender side, it is easy to know the retry window because the sender is performing the retry. However, from the receiver side, it is difficult to know whether a frame was sent as part of retry or normal flow. The problem comes from the Ultra Ethernet Specification: once there is a sequence mismatch/frame drop, a receiver implementation discards subsequent frames, because everything will be retried. In the test scenarios described herein, a test device emulating an LLR receiver discards such frames and stores the last received good sequence number. From the example in FIG. 1, the sender transmits the following sequence of frames:
1,2,3,5,6,7,4,5,6,7,8,9,10

After receiving frames 1, 2, and 3 and sending the NACK, the receiver begins discarding frames 5, 6, and 7. The retry starts when the sender starts retransmission of frame 4. In a test scenario, the test device emulating the receiver similarly discards frames 5, 6, and 7 and then starts processing frames 4, 5, 6, 7, 8, 9, 10. The receiver frame-processing logic sees frames 1, 2, 3, 4, 5, 6, 7, 8, 9, 10. However, the test device does not know whether frames 7 and 8 are part of the retry window or not because it discarded frames 5, 6, and 7 and only stored the last good sequence number of the last in-sequence frame that was received (3 in this case). Because the test device does not know when the retry window ends, the test device seeking to verify proper behavior of an LLR sender during retry window invocation needs a mechanism to determine the boundaries of the retry so that the above-specified LLR behaviors can be verified.

To address the aforementioned issues, instead of storing only the last good sequence number, the test device emulating the receiver also stores the highest sequence number observed (after receiving an out-of-sequence frame) before receiving a frame with a sequence number=last-good-seq+1. In the example illustrated in FIG. 1, instead of storing only sequence number 3, the test device stores sequence numbers 3 and 7. The test device then treats the time duration between receipt of the frame with “received last-good-seq+1” (sequence number 4 in line 6) and receipt of the frame with “last sequence number” as the retry window.

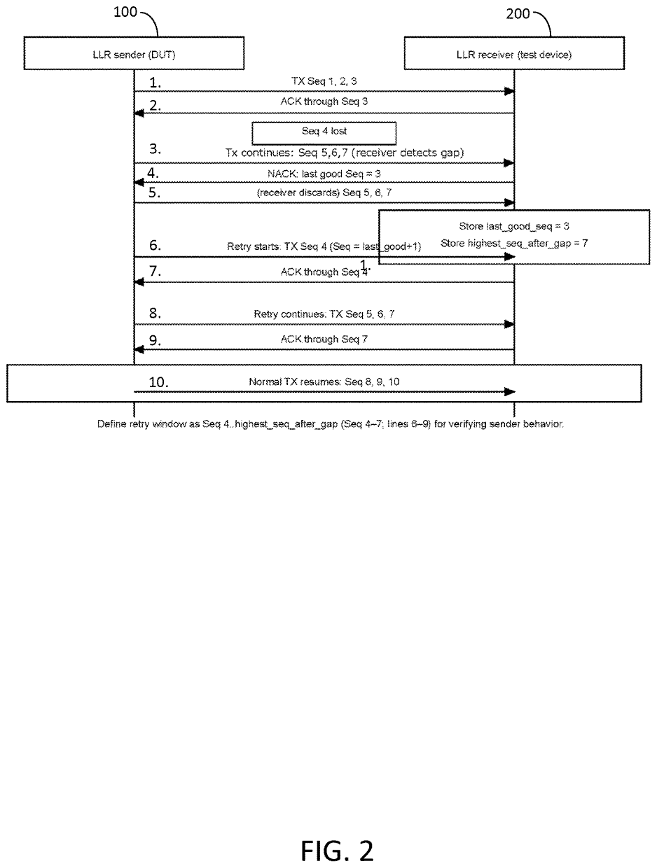

In FIG. 2, test device 200 determines the retry-window boundaries using the same message-flow notation used for FIG. 1. In line 1, LLR sender 100 sends LLR frames to test device 200 emulating an LLR receiver. In line 2, test device 200 transmits an ACK acknowledging frames 1-3. After line 2, frame 4 is lost. In line 3, LLR sender 100 continues by sending frames 5, 6, and 7.

In line 4, upon detecting an out-of-sequence frame and transmitting a NACK, test device 200 stores a last-good sequence number (e.g., 3). In line 5, while discarding subsequent out-of-sequence frames, test device 200 stores a highest sequence number observed after the gap and prior to retry (e.g., 7). When test device 200 later receives the frame having sequence number last-good+1 (e.g., 4) in line 6, the test device identifies that frame as the start of the retry window, and treats frames with sequence numbers up to the stored highest sequence number (e.g., 4-7, corresponding to lines 6-9) as within the retry window for purposes of verifying sender behavior. In line 10, normal transmission resumes with the transmission of frames with sequence numbers 8, 9, and 10.

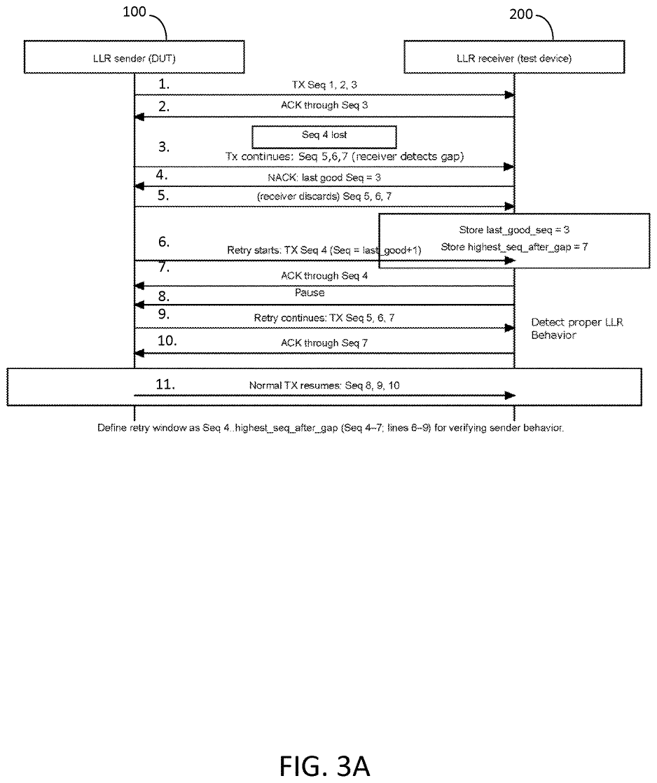

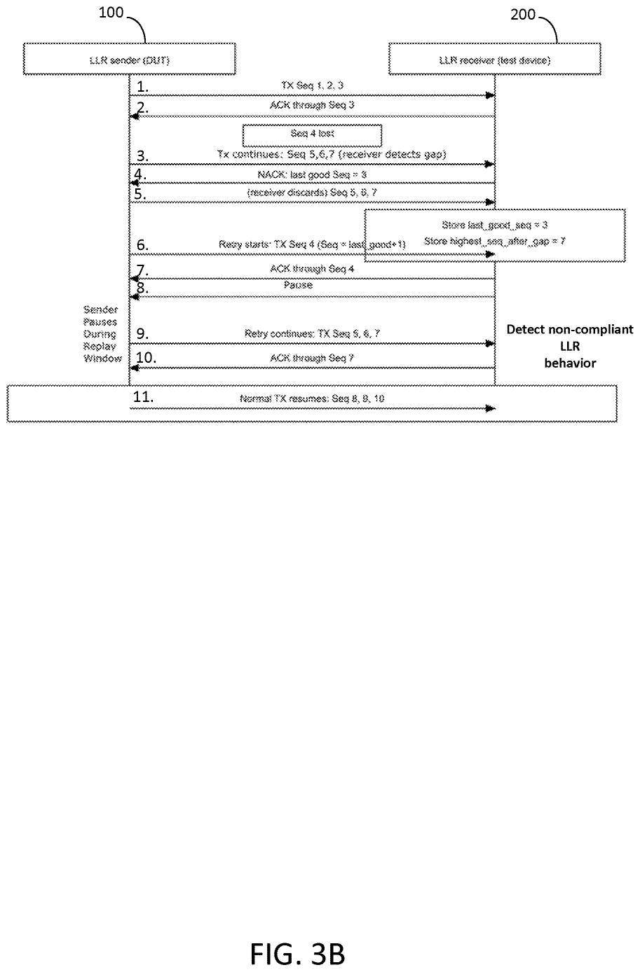

FIG. 3A illustrates an example where test device 200 uses the method of FIG. 2 to validate an LLR sender behavior during retry window invocation by sending a pause frame to the LLR sender during retry window invocation and monitoring the behavior of the LLR sender during the retry window. The message flow in FIG. 3A is the same as the message flow in FIG. 2 except that in line 8, during the retry window and after saving the last good and highest sequence numbers, test device 200 sends an Ethernet pause frame to LLR sender 100. Test device 200 includes in the Ethernet pause frame a time interval that specifies how long LLR sender 100 should pause sending traffic to test device 200. As indicated above, during the retry window an LLR sender should not pause sending retransmitted traffic. In the example illustrated in FIG. 3A, LLR sender 100 does not pause sending retransmitted frames during the retry window. When test device 200 receives retransmitted frames 5, 6, and 7 during the retry window and prior to expiration of the interval specified in the pause frame, test device 200 may detect proper (specification-compliant) LLR sender behavior.

FIG. 3B is a message flow diagram illustrating the same scenario as FIG. 3A except that the LLR sender pauses sending retransmitted Ethernet frames in response to receiving the pause frame during retry window invocation. In FIG. 3B, in line 8, the test device sends the Ethernet pause frame including the pause interval to LLR sender 100. In response to receiving the pause frame, LLR sender 100 pauses sending the retransmitted frames for the specified pause interval and then resumes sending the retransmitted frames. When test device 200 receives the retransmitted frames delayed by at least the pause interval, test device 200 may detect non-compliant LLR sender behavior.

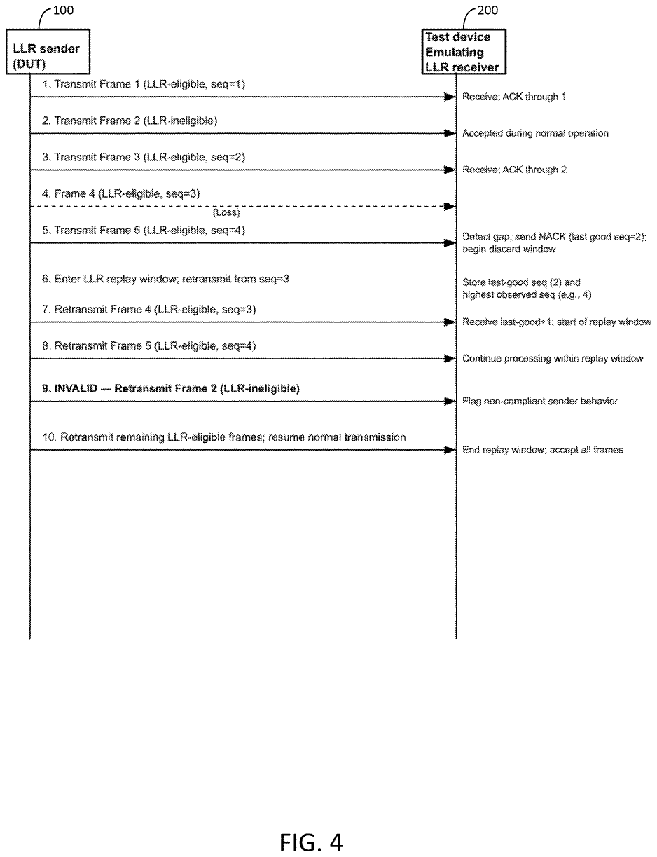

FIG. 4 is a message flow diagram illustrating invalid retransmission of an LLR-ineligible frame during an LLR retry window. FIG. 4 is a message flow diagram illustrating an example sequence of communications between a LLR sender 100, acting as a device under test (DUT), and a test device 200 that emulates an LLR receiver, and further illustrates detection of non-compliant sender behavior during an LLR retry window.

As shown in line 1 of FIG. 4, LLR sender 100 transmits an LLR-eligible frame having sequence number 1 to test device 200. Test device 200 receives the frame and returns an acknowledgement (ACK) indicating successful receipt through sequence number 1. In line 2, LLR sender 100 transmits an LLR-ineligible frame, which is received and accepted by test device 200 during normal operation. In line 3, LLR sender 100 transmits another LLR-eligible frame having sequence number 2, which is received by test device 200, and test device 200 returns an ACK through sequence number 2.

In line 4, an LLR-eligible frame having sequence number 3 is transmitted by LLR sender 100 but is lost on the link and is not received by test device 200. Despite the loss, LLR sender 100 continues transmission, and in line 5 transmits a subsequent LLR-eligible frame having sequence number 4. Upon receiving the out-of-sequence frame in line 5, test device 200 detects a gap relative to the next expected sequence number (3) and transmits a negative acknowledgement (NACK) identifying the last good sequence number as 2. In response to the out-of-sequence condition, test device 200 begins discarding subsequently received LLR-eligible frames in accordance with the LLR protocol.

In line 6, after receiving the NACK, LLR sender 100 enters an LLR retry window and begins retransmitting frames from its replay buffer starting with the frame having a sequence number equal to last-good+1. Concurrently, test device 200 stores both the last good sequence number and a highest sequence number observed during the discard period prior to retry.

In line 7, test device 200 receives the retransmitted frame having a sequence number equal to last-good+1 (e.g., sequence number 3) and identifies this frame as the start of the retry window. In line 8, LLR sender 100 retransmits an additional LLR-eligible frame within the retry window (e.g., sequence number 4), which test device 200 receives and processes as a retry-window frame based on the stored sequence number boundaries.

FIG. 4 further illustrates a non-compliant sender behavior during retry. In line 9, LLR sender 100 retransmits an LLR-ineligible frame while still within the retry window. Upon detecting retransmission of an LLR-ineligible frame during the retry window identified by sequence number boundaries, test device 200 flags the behavior of LLR sender 100 as non-compliant with LLR protocol requirements.

In line 10, after retransmission of frames in the replay buffer is complete, LLR sender 100 resumes normal transmission. Test device 200 determines the end of the retry window after receipt of the frame corresponding to the highest stored sequence number and resumes normal acceptance and processing of both LLR-eligible and LLR-ineligible frames.

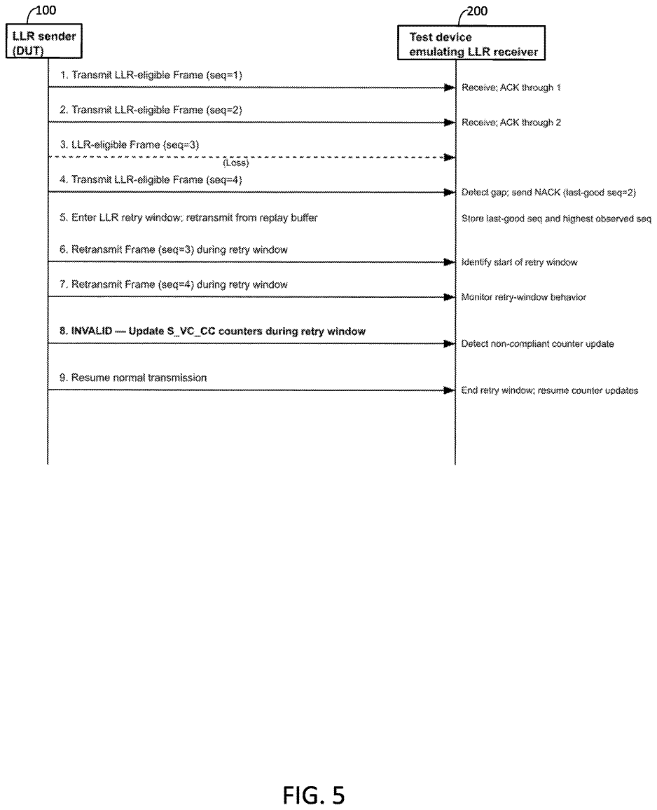

As indicated above, another LLR sender behavior that it is desirable to verify during the LLR retry window is to confirm that the retransmission of LLR-eligible frames during the LLR retry window does not update the S_VC_CC counters. FIG. 5 is a message flow diagram illustrating an example scenario in which a test device detects non-compliant link level retry (LLR) sender behavior involving updating of S_VC_CC counters during an LLR retry window.

As shown in line 1 of FIG. 5, LLR sender 100, acting as a device under test (DUT), transmits an LLR-eligible frame having sequence number 1 to test device 200, which emulates an LLR receiver. Test device 200 receives the frame and returns an acknowledgement (ACK) indicating successful receipt through sequence number 1. In line 2, LLR sender 100 transmits another LLR-eligible frame having sequence number 2, which is received by test device 200, and test device 200 returns an ACK through sequence number 2.

In line 3, an LLR-eligible frame having sequence number 3 is transmitted by LLR sender 100 but is lost on the link and is not received by test device 200. Despite the loss, LLR sender 100 continues transmission, and in line 4 transmits a subsequent LLR-eligible frame having sequence number 4. Upon receiving the out-of-sequence frame in line 4, test device 200 detects a gap relative to the next expected sequence number and transmits a negative acknowledgement (NACK) identifying the last good sequence number (for example, sequence number 2).

In line 5, after transmission of the NACK, LLR sender 100 enters an LLR retry window and begins retransmitting frames from its replay buffer. Concurrently, test device 200 stores the last good sequence number and a highest sequence number observed during the discard period prior to retry.

In line 6, LLR sender 100 retransmits an LLR-eligible frame from the replay buffer having a sequence number equal to last-good+1 (e.g., sequence number 3). Test device 200 receives this frame and identifies it as the start of the LLR retry window. In line 7, LLR sender 100 retransmits an additional LLR-eligible frame during the retry window (e.g., sequence number 4), and test device 200 continues monitoring sender behavior during the retry window.

FIG. 5 further illustrates a non-compliant sender behavior during the retry window. In line 8, LLR sender 100 updates one or more S_VC_CC counters while still within the LLR retry window. Because the Ultra Ethernet specification requires that retransmission of LLR-eligible frames during the retry window must not update S_VC_CC counters, test device 200 detects the counter update and flags the behavior of LLR sender 100 as non-compliant.

In line 9, after completion of the retry window, LLR sender 100 resumes normal transmission. Test device 200 determines termination of the retry window based on the stored sequence number boundaries and resumes normal monitoring and acceptance of sender behavior, including counter updates performed outside of the retry window.

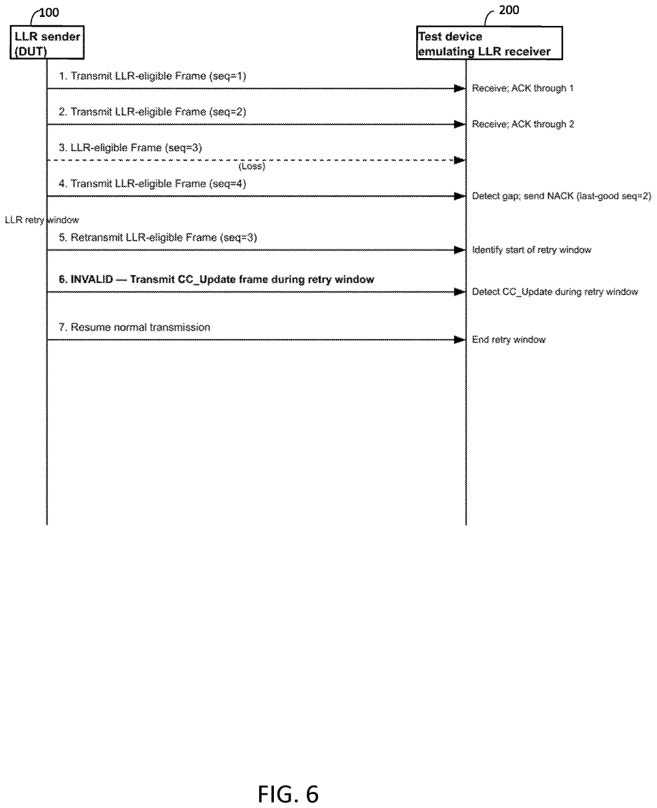

As indicated above, another LLR sender behavior that it is desirable to verify is that during the LLR retry window, no new CC_Update frame is transmitted. FIG. 6 is a message flow diagram illustrating a non-compliant link level retry (LLR) sender behavior in which a CC_Update frame is transmitted during an LLR retry window. As shown in line 1 of FIG. 6, LLR sender 100, acting as a device under test (DUT), transmits an LLR-eligible frame having sequence number 1 to test device 200, which emulates an LLR receiver. Test device 200 receives the frame and returns an acknowledgement (ACK) indicating successful receipt through sequence number 1. In line 2, LLR sender 100 transmits another LLR-eligible frame having sequence number 2, which is received by test device 200, and test device 200 returns an ACK through sequence number 2.

In line 3, an LLR-eligible frame having sequence number 3 is transmitted by LLR sender 100 but is lost on the link and is not received by test device 200. Despite the loss, LLR sender 100 continues transmission, and in line 4 transmits a subsequent LLR-eligible frame having sequence number 4. Upon receiving the out-of-sequence frame in line 4, test device 200 detects a gap relative to the next expected sequence number and transmits a negative acknowledgement (NACK) identifying the last good sequence number (for example, sequence number 2).

In line 5, after transmission of the NACK, LLR sender 100 enters an LLR retry window and begins retransmitting LLR-eligible frames from its replay buffer, starting with the frame having a sequence number equal to last-good+1. Test device 200 receives the retransmitted frame and identifies it as occurring within the LLR retry window.

FIG. 6 further illustrates a non-compliant sender behavior during the retry window. In line 6, while the LLR retry window is still active, LLR sender 100 transmits a CC_Update frame. Because the Ultra Ethernet Specification requires that no new CC_Update frame be transmitted during the LLR retry window, test device 200 detects the CC_Update frame transmission during the retry window and flags the behavior of LLR sender 100 as non-compliant. In line 7, after completion of retransmission of frames in the replay buffer, LLR sender 100 resumes normal transmission. Test device 200 determines the end of the LLR retry window and resumes normal acceptance and processing of frames transmitted by the sender.

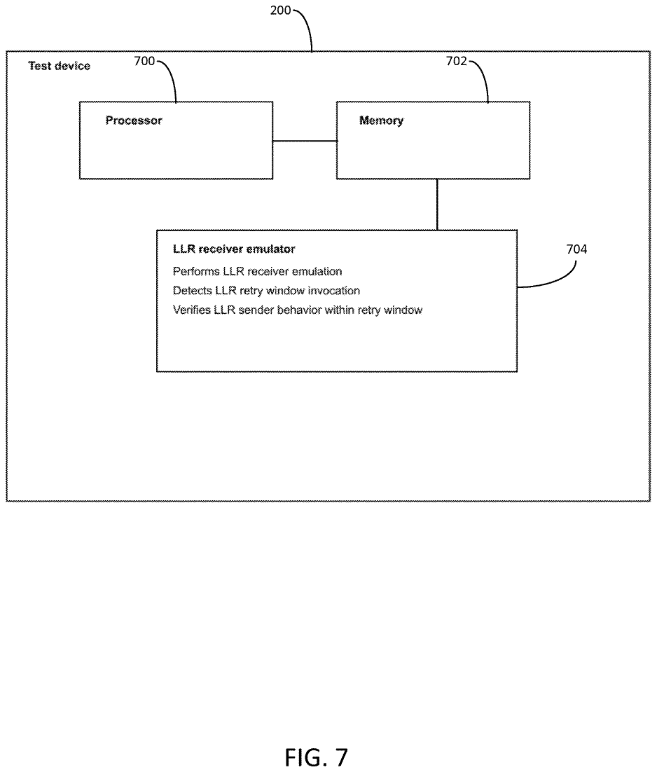

FIG. 7 is a block diagram of a test device for emulating an LLR receiver capable of identifying when an LLR sender is transmitting frames within the retry window and for verifying LLR sender behavior within the retry window. Referring to FIG. 7, test device 200 includes at least one processor 700 and a memory 702. Test device 200 includes LLR receiver emulator 704 for performing the operations described herein for LLR receiver emulation, LLR retry window detection, and LLR sender behavior verification. LLR receiver emulator 704 may be implemented using computer executable instructions stored in memory 702 and executed by processor 700.

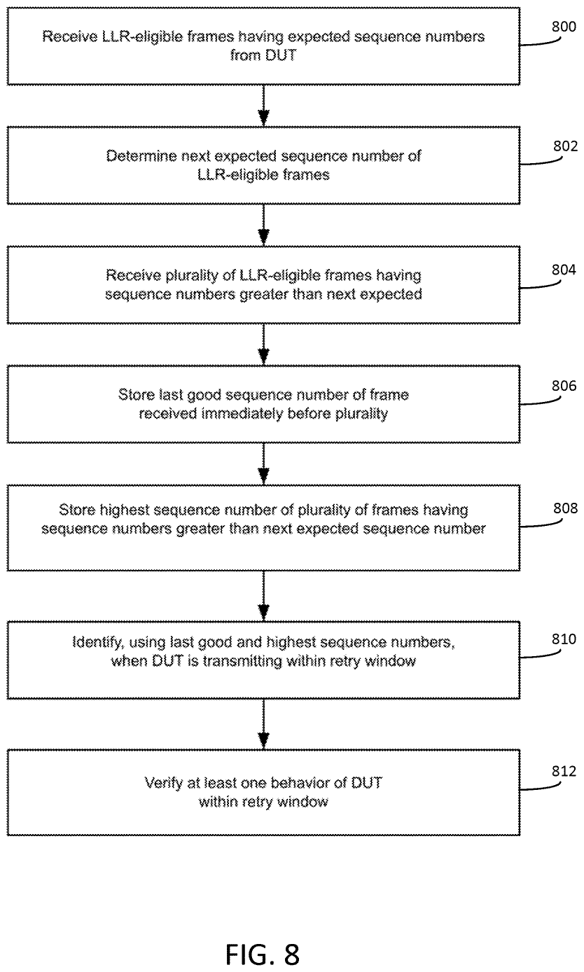

FIG. 8 is a flow chart illustrating an exemplary process performed by a test device emulating an LLR receiver for determining when an LLR sender is transmitting frames within an LLR retry window and for verifying behaviors of the LLR sender within the retry window. Referring to FIG. 8, in step 800, receiving, by a test device emulating an LLR receiver, LLR-eligible frames having expected sequence numbers transmitted by the DUT. For example, a test device, such as test device 200 may receive LLR-eligible frames from an LLR sender, such as an Ultra Ethernet device.

In step 802, the process further includes determining, by the test device, a next expected sequence number of the LLR-eligible frames. For example, the test device may calculate the next expected sequence number by incrementing the sequence number of the last received, in-order LLR-eligible frame.

In step 804, the process further includes receiving, by the test device and from the DUT, a plurality of LLR-eligible frames having sequence numbers that are greater than a next expected sequence number and prior to receiving a link level frame having the next expected sequence number.

In step 806, the process further includes storing, by the test device, a last good sequence number of an LLR-eligible frame received immediately before receiving the plurality of LLR-eligible frames having the sequence numbers that are greater than the next expected sequence number.

As shown in step 808, the process further includes storing, by the test device, a highest sequence number of the sequence numbers of the plurality of LLR-eligible having sequence numbers greater than the next expected sequence number. For example, consistent with the message-flow examples of FIGS. 3-6, after detecting an out-of-sequence condition and transmitting a negative acknowledgement (NACK), the test device may discard subsequently received LLR-eligible frames while monitoring their sequence numbers. In a scenario in which the test device last successfully received sequence number 3 and subsequently observes frames having sequence numbers 5, 6, and 7 prior to receiving a retransmitted frame having sequence number 4, the test device may store sequence number 7 as the highest observed sequence number during the discard period.

In step 810, the process further includes identifying, by the test device and using the last good sequence number and the highest sequence number, when the DUT is transmitting frames within the retry window. For example, consistent with the retry-window detection illustrated in FIGS. 3A, 3B, 4, 5, and 6, the test device may identify receipt of a frame having sequence number equal to last-good+1 (e.g., sequence number 4) as the start of the retry window, and may treat subsequently received frames having sequence numbers less than or equal to the stored highest sequence number (e.g., sequence numbers 4-7) as occurring within the retry window. Using this sequence-number-based boundary determination allows the test device to distinguish retry-window traffic from normal post-retry traffic without requiring explicit signaling from the DUT.

In step 812, the process further includes verifying, by the test system, at least one behavior of the DUT within the retry window. For example, and as illustrated in FIGS. 3A and 3B, the test device may transmit a pause frame to the DUT during the retry window and verify whether the DUT improperly pauses retransmission of LLR-eligible frames in response to the pause frame. In another example, consistent with FIG. 4, the test device may monitor retransmitted frames within the retry window to verify that only LLR-eligible frames are retransmitted and may flag the DUT as non-compliant if an LLR-ineligible frame is transmitted during the retry window. In a further example, consistent with FIG. 5, the test device may monitor whether the DUT updates one or more S_VC_CC counters during the retry window and may flag non-compliance if such counter updates are detected. In yet another example, consistent with FIG. 6, the test device may monitor for transmission of CC_Update frames during the retry window and may flag non-compliant DUT behavior if a CC_Update frame is transmitted while the retry window remains active.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for detecting link level retry (LLR) window invocation by a device under test (DUT), the method comprising:
receiving, by a test device emulating a link level receiver, LLR-eligible frames having expected sequence numbers transmitted by the DUT;
determining, by the test device, a next expected sequence number of the LLR-eligible frames;
storing, by a test device emulating an LLR receiver, a last good sequence number of an LLR-eligible frame received immediately before receiving a plurality of LLR-eligible frames having sequence numbers that are greater than the next expected sequence number;
storing, by the test device, a highest sequence number of the sequence numbers of the plurality of LLR-eligible frames having the sequence numbers that are greater than the next expected sequence number;
identifying, by the test device and using the last good sequence number and the highest sequence number, when the DUT is transmitting frames within a retry window; and
verifying, by the test device, at least one behavior of the DUT within the retry window.

2. The method of claim 1 wherein receiving the LLR-eligible frames includes receiving Ultra Ethernet frames.

3. The method of claim 2 wherein determining the next expected sequence number of the LLR-eligible frames includes reading the sequence numbers from LLR portions of the Ultra Ethernet frames and incrementing the sequence number of a last received LLR-eligible frame.

4. The method of claim 1 wherein identifying when the DUT is transmitting the frames within the retry window includes identifying frames received after the frame having the sequence number that is equal to the next expected sequence number and having sequence numbers less than or equal to the highest sequence number as being within the retry window.

5. The method of claim 1 comprising identifying the LLR-eligible frame having the next expected sequence number as being the first frame of the retry window.

6. The method of claim 1 wherein verifying at least one link level behavior of the device under test within the retry window includes verifying at least one Ultra Ethernet link level behavior of the DUT during the retry window.

7. The method of claim 6 wherein verifying at least one Ultra Ethernet link level behavior of the DUT within the retry window includes determining whether the DUT does not pause sending of previously transmitted frames within the retry window in response to receiving a pause frame.

8. The method of claim 6 wherein verifying at least one Ultra Ethernet link level behavior of the DUT within the retry window includes determining whether the DUT transmits only LLR-eligible frames within the retry window.

9. The method of claim 6 wherein verifying at least one Ultra Ethernet link level behavior of the DUT within the retry window includes determining whether the DUT updates S_VC_CC counters within the retry window.

10. The method of claim 6 wherein verifying at least one Ultra Ethernet link level behavior of the DUT during the retry window invocation includes determining whether the DUT transmits a CC_Update frame within the retry window.

11. A system for detecting link level retry (LLR) window invocation by a device under test (DUT), the system comprising:
at least one processor; and
a memory storing instructions that, when executed by the at least one processor, cause the system to:
receive, by a test device emulating a link level receiver, LLR-eligible frames having expected sequence numbers transmitted by the DUT;
determine a next expected sequence number of the LLR-eligible frames;
store a last good sequence number of an LLR-eligible frame received immediately before receiving a plurality of LLR-eligible frames having sequence numbers that are greater than the next expected sequence number;
store a highest sequence number of the sequence numbers of the plurality of LLR-eligible frames having the sequence numbers that are greater than the next expected sequence number; and
identify, using the last good sequence number and the highest sequence number, when the DUT is transmitting frames within a retry window; and verify at least one behavior of the DUT within the retry window.

12. The system of claim 11 wherein the instructions to receive the LLR-eligible frames include instructions to receive Ultra Ethernet frames.

13. The system of claim 11 wherein the instructions to identify when the DUT is transmitting the frames within the retry window include instructions to identify frames received after a frame having a sequence number that is equal to the next expected sequence number and having sequence numbers less than or equal to the highest sequence number as being within the retry window.

14. The system of claim 11 wherein the instructions cause the system to identify the LLR-eligible frame having the next expected sequence number as being a first frame of the retry window.

15. The system of claim 11 wherein the instructions to verify at least one link level behavior of the DUT within the retry window include instructions to verify at least one Ultra Ethernet link level behavior of the DUT during the retry window.

16. The system of claim 15 wherein the instructions to verify at least one Ultra Ethernet link level behavior of the DUT within the retry window include instructions to determine whether the DUT does not pause sending of previously transmitted frames within the retry window in response to receiving a pause frame.

17. The system of claim 15 wherein the instructions to verify at least one Ultra Ethernet link level behavior of the DUT within the retry window include instructions to determine whether the DUT transmits only LLR-eligible frames within the retry window.

18. The system of claim 15 wherein the instructions to verify at least one Ultra Ethernet link level behavior of the DUT within the retry window include instructions to determine whether the DUT updates S_VC_CC counters within the retry window.

19. The system of claim 15 wherein the instructions to verify at least one Ultra Ethernet link level behavior of the DUT during the retry window invocation include instructions to determine whether the DUT transmits a CC_Update frame within the retry window.

20. A non-transitory computer readable medium having stored thereon computer executable instructions that when executed by at least one processor of a test device emulating a link level receiver cause the test device to:
receive LLR-eligible frames having expected sequence numbers transmitted by a device under test (DUT);
determine a next expected sequence number of the LLR-eligible frames; store a last good sequence number of an LLR-eligible frame received immediately before receiving a plurality of LLR-eligible frames having sequence numbers that are greater than the next expected sequence number;
store a highest sequence number of the sequence numbers of the plurality of LLR-eligible frames having the sequence numbers that are greater than the next expected sequence number;
identify, using the last good sequence number and the highest sequence number, when the DUT is transmitting frames within a retry window; and
verify at least one behavior of the DUT within the retry window.
